(19) United States
(12) Patent Application Publication
(10) Pub. No.: US 2026/0055227 A1
(43) Pub. Date: Feb. 26, 2026

(54) LOW VISCOSITY FUNCTIONALIZED ETHYLENE COPOLYMER

(71) Applicant: Dow Global Technologies LLC, Midland, MI (US)

(72) Inventors: Santosh S. Bawiskar, Sugarland, TX (US); Jong-Young Lee, Sugarland, TX (US); Lin Jin, Pearland, TX (US); Rajesh P. Paradkar, Lake Jackson, TX (US); Chad J. Richard, Lake Jackson, TX (US)

(73) Assignee: Dow Global Technologies LLC, Midland, MI (US)

(21) Appl. No.: 19/105,616

(22) PCT Filed: Aug. 30, 2023
(86) PCT No.: PCT/US2023/073167

§ 371 Date: Feb. 21, 2025

Related U.S. Application Data
(60) Provisional application No. 63/402,764, filed on Aug. 31, 2022.

(51) Int. Cl. C08G 59/02; B29C 48/00; B29C 48/40

(52) U.S. Cl. CPC C08G 59/022; B29C 48/022; B29C 48/40; B29K 2065/00

(57) ABSTRACT

The present disclosure provides embodiments of an epoxy-functionalized ethylene-based polymer and process for manufacturing that may include: extruding a reactive mixture to form the epoxy-functionalized ethylene-based polymer, wherein the reactive mixture includes an ethylene-based polymer having a viscosity less than or equal to 50,000 cP at 177° C.: an epoxy-functional monomer: a peroxide; and a vinyl terminated multifunctional coagent having a functionality of 2 or more.

### CROSS-REFERENCE TO RELATED APPLICATIONS

This application claims the benefit of U.S. Provisional Application Ser. No. 63/402,764 filed Aug. 31, 2023, the entire disclosure of which is hereby incorporated herein by reference.

### TECHNICAL FIELD

Embodiments described herein generally relate to a method of grafting an epoxy functionality onto low viscosity ethylene-based copolymers.

### BACKGROUND

Grafted or functionalized low viscosity ethylene-based copolymers are useful as recycle compatibilizers. Epoxy-functionalized ethylene-based copolymers are of interest for these applications, at least in part, due to the reaction between the epoxy group of the epoxy-functionalized ethylene-based copolymer with acid groups (e.g. in a polyester).

The common epoxy-functional monomers grafted onto polyolefins or polyolefin copolymers or block copolymers are glycidyl acrylate, glycidyl methacrylate (GMA), and allyl glycidyl ether (AGE). However, it is also possible to graft other epoxy-functional vinyl monomers onto polyolefins or polyolefin copolymers or block copolymers. Typically, the grafting is done using peroxide initiation. However, low grafting efficiencies and the tendency of the monomer to homopolymerize (rather than graft) and take part in other side reactions make it challenging to graft epoxy functionality onto ethylene copolymers. Further, due to the low viscosity of the ethylene copolymer (e.g., less than 50,000 cP at 177° C.), an appropriate extruder and peroxide combination are required in order to achieve the right graft structure and complete the reaction.

Polyethylene containing GMA functional groups can be made via copolymerization in a reactor, but there is a lower limit for the viscosity (or higher limit for the melt index) of the resin. This lower limit is problematic because a low viscosity is needed to achieve good compatibilization in packaging recycling.

Therefore, there exists a need for a more efficient process for grafting epoxy-functional monomers onto low viscosity polyolefins that avoids the low viscosity limitations that exist for copolymerization methods.

### SUMMARY

Embodiments of the present disclosure meet the above-described needs by utilizing a coagent during the grafting process, which enhances the grafting reaction of an epoxy-functional monomer onto a low viscosity polyolefin. It has been discovered that specific coagents comprising vinyl groups help graft the epoxy-functional monomer onto the low viscosity polyolefin while improving graft level and graft efficiency, and minimizing homopolymer formation.

In one embodiment, the grafting process of the present disclosure involves manufacturing an epoxy-functionalized ethylene-based polymer, the process comprising: extruding a reactive mixture to form the epoxy-functionalized ethylene-based polymer, wherein the reactive mixture comprises: an ethylene-based polymer having a viscosity less than or equal to 50,000 cP at 177° C.; an epoxy-functional monomer; a peroxide; and a vinyl terminated multifunctional coagent having a functionality of 2 or more.

These and other embodiments are described in more detail in the following detailed description.

### DETAILED DESCRIPTION

Specific embodiments of the present application will now be described. These embodiments are provided so that this disclosure will be thorough and complete and will fully convey the scope of the subject matter to those skilled in the art.

As described above, the present disclosure provides a process for manufacturing an epoxy-functionalized ethylene-based polymer, the process comprising: extruding a reactive mixture to form the epoxy-functionalized ethylene-based polymer, wherein the reactive mixture comprises: an ethylene-based polymer having a viscosity less than or equal to 50,000 cP at 177° C.; an epoxy-functional monomer; a peroxide; and a vinyl terminated multifunctional coagent having a functionality of 2 or more.

### Ethylene-Based Polymer

In one embodiment, the ethylene-base polymer is an ethylene/α-olefin interpolymer, wherein the α-olefin is a C3-C20 α-olefin or a C3-C10 α-olefin. In one embodiment, the ethylene-base polymer is an ethylene/α-olefin copolymer, wherein the α-olefin is a C3-C20 α-olefin or a C3-C10 α-olefin.

In one embodiment, the reactive mixture comprises 80 to 97 wt % ethylene-based polymer. In some embodiments, the reactive mixture comprises 83 to 97 wt % ethylene-based polymer, 85 to 97 wt % ethylene-based polymer, 85 to 96 wt % ethylene-based polymer, 87 to 96 wt % ethylene-based polymer, 88 to 96 wt % ethylene-based polymer, 89 to 96 wt % ethylene-based polymer, or 89.5 to 96 wt % ethylene-based polymer. All individual values and subranges from 80 to 97 wt % ethylene-based polymer are included herein and disclosed herein.

In one embodiment, the ethylene-based polymer has a melt viscosity at 350° F. (177° C.) less than or equal to 50,000 cP, or less than or equal to 45,000 cP, or less than or equal to 40,000 cP. In one embodiment, the ethylene-based polymer has a melt viscosity at 350° F. (177° C.) less than or equal to 30,000 cP, less than or equal to 25,000 cP, less than or equal to 20,000 cP, or less than or equal to 15,000 cP. In one embodiment, the ethylene-based polymer has a melt viscosity at 350° F. (177° C.) greater than or equal to 1.000 cP, greater than or equal to 2,000 cP. greater than or equal to 3,000 cP, greater than or equal to 4,000 cP, or greater than or equal to 5,000 cP. In one embodiment, the viscosity of the ethylene-based polymer is from 5,000 to 50,000 cP at 350° F. (177° C.). For the purposes of the present disclosure, a “low viscosity” ethylene-based polymer refers to an ethylene-based polymer with a melt viscosity at 350° F. (177° C.) less than or equal to 50,000 cP.

In one embodiment, the ethylene-based polymer has a density less than or equal to 0.900, less than or equal to 0.895, less than or equal to 0.890, less than or equal to 0.885, less than or equal to 0.880, or less than or equal to 0.875 g/cc (g/cc=g/cm³). In one embodiment, the ethylene-based polymer has a density greater than or equal to 0.850, greater than or equal to 0.855. greater than or equal to 0.860, or greater than or equal to 0.865 g/cc. In one embodiment, the ethylene-based polymer has a density from 0.850 to 0.900 g/cc.

### Epoxy-Functional Monomer

In one embodiment, the epoxy-functional monomer comprises one or more of glycidyl acrylate, glycidyl methacrylate (GMA), and allyl glycidyl ether (AGE). Other suitable epoxy-functional monomers include, without limitation, (3,4-epoxycyclohexyl) methyl acrylate. (3.4-epoxycyclohexyl)methyl acrylate, and 1.2-epoxy-4-vinylcyclohexane.

In one embodiment, the reactive mixture comprises 0.3% to 10.0 wt % epoxy-functional monomer, based on the total weight of the reactive mixture. In some embodiments, the reactive mixture may comprise 2.5 to 9.5 wt % epoxy-functional monomer. 2.5 to 9.0 wt % epoxy-functional monomer. 3.0 to 9.0 wt % epoxy-functional monomer, 3.0 to 8.5 wt % epoxy-functional monomer, or 3.0 to 8.0 wt % epoxy-functional monomer. All individual values and subranges from 0.3% to 10.0 wt % epoxy-functional monomer are included herein and disclosed herein.

### Coagent

In one embodiment, the reactive mixture comprises 0.1 to 5.0 wt % vinyl terminated multifunctional coagent. In some embodiments, the reactive mixture may comprise 0.6 to 4.6 wt % vinyl terminated multifunctional coagent, 0.7 to 4.2 wt % vinyl terminated multifunctional coagent, 0.8 to 3.8 wt % vinyl terminated multifunctional coagent. 0.9 to 3.4 wt % vinyl terminated multifunctional coagent. 1.0 to 3.0 wt % vinyl terminated multifunctional coagent, or 1.1 to 2.6 wt % vinyl terminated multifunctional coagent. All individual values and subranges from 0.1 to 5.0 wt % vinyl terminated multifunctional coagent are included herein and disclosed herein.

In one embodiment, the vinyl terminated multifunctional coagent comprises divinylbenzene. Other suitable vinyl terminated multifunctional coagents include, without limitation, trivinylcyclohexane and diethyleneglycol divinyl ether.

The molecular structure of the vinyl terminated multifunctional coagent may be represented by Formula (I), where n>=2:

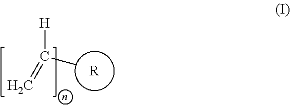

In one embodiment, the molecular structure of the vinyl terminated multifunctional coagent may be represented by Formula (I), where n>=3.

In one embodiment, the vinyl terminated multifunctional coagent comprises an acrylate terminated multifunctional coagent. The molecular structure of the acrylate terminated multifunctional coagent may be represented by Formula (II), where n>=2:

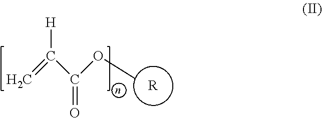

In one embodiment, the molecular structure of the acrylate terminated multifunctional coagent may be represented by Formula (II), where n>=3.

In some embodiments, the acrylate terminated multifunctional coagent comprises trimethylolpropane triacrylate (TMPTA SR351H. SR351HP). TMPTA is commercially available from Sartomer. Other suitable acrylate terminated multifunctional coagents include, without limitation: cyclohexane dimethanol diacrylate (SR406), alkoxylated hexanediol diacrylate (SR561. SR562, SR563, SR564), alkoxylated neopentyl glycol diacrylate (SR9043). 1.3-butylene glycol diacrylate (SR212B), 1.4-butanediol diacrylate (SR213), diethylene glycol diacrylate (DEGDA. SR230), 1,6-hexanediol diacrylate (HDDA, SR238. SR238B, SR238BTF), neopentyl glycol diacrylate, polyethylene glycol diacrylate (SR259, SR344, SR610), tetraethylene glycol diacrylate (SR268), tripropylene glycol diacrylate (TPGDA, SR306F. SR306FTF), ethoxylated bisphenol A diacrylate (SR349, SR601. SR602, SR9038, CN120A60), dipropylene glycol diacrylate (DPGDA, tricyclodecane dimethanol diacrylate (SR833S), neopentylglycol diacrylate (SR9209A), proxylated neopentyl glycol diacrylate (SR9003B), tris(2-hydroxy ethyl) isocyanurate triacrylate (THEICTA SR368, SR368D), ethoxylated trimethylolpropane triacrylate (SR415. SR454, SR499, SR502. SR9035), pentaerythritol triacrylate (PETIA SR444), propoxylated trimethylolpropane triacrylate (SR492. SR501), propoxylated glyceryl triacrylate (GPTA, SR9020), pentaerylthritol tetraacrylate (SR295), di-trimethylolpropane tetraacrylate (SR355), dipentaerythritol pentaacrylate (DiPEPA. SR399. SR399LV), ethoxylated pentaerythritol tetraacrylate (SR494), alkoxylated pentaerythritol tetraacrylate (LM5401), low-viscosity diacrylate oligomer (CN132), low-viscosity triacrylate oligomer (CN133US), etc., which are commercially available from Sartomer.

In some embodiments, the reactive mixture comprises a combination of two or more coagents.

### Peroxide

Suitable peroxides include, but are not limited to, the following: LUPEROX 101 (2.5-dimethyl-2,5-di(t-butylperoxy) hexane) CAS #78-63-7; LUPEROX DC (dicumyl peroxide). CAS #80-43-3; LUPEROX DTA (di(t-amyl) peroxide) CAS #10508 Sep. 5; LUPEROX P (t-butyl peroxybenzoate) CAS #614-45-9; LUPEROX TAP (t-amyl peroxybenzoate) CAS #4511-39-1; LUPEROX F (a.a′-bis (t-butylperoxy)-diisopropylbenzene) CAS #25155-25-3; and LUPEROX TBEC (OO-t-butyl O-(2-ethylhexyl) monoperoxycarbonate) CAS #34443 Dec. 4. LUPEROX 101 is the preferred peroxide. The purpose of the peroxide is to function as a free-radical initiator by producing radical species for radical reactions, in particular, grafting reactions. The peroxide may decompose into at least one primary radical selected from the following radicals: (a) RCOO•, wherein R is an alkyl; (b) RO•, wherein R is an alkyl; or c) ROC(O) O·, wherein R is an alkyl.

In some embodiments, the reactive mixture comprises a combination of two or more peroxides.

### Extruder

Examples of extruders which may be used to extrude the reactive mixture to form the epoxy-functionalized ethylene-based polymer include, but are not limited to, co-rotating intermeshing twin screw extruders, counter-rotating twin screw extruders, tangential twin screw extruders. Buss kneader extruders, planetary extruders, and single screw extruders. Further, features of interest are design specifications including the length/diameter ratio (L/D ratio) and mixing sections (screw design). Typically, with a single extruder, the maximum L/D ratio is about 60. For longer L/D ratios, two extruders are coupled. Screw designs include, but are not limited to, those comprising of mixing elements, such as kneading disc blocks, left handed screw elements, turbine mixing elements, gear mixing elements, and combinations made thereof.

Although grafting in a twin screw extruder with an appropriate residence time (30 seconds to 3 minutes) to complete the reaction was found to give the best results, other extruders including but not limited to those described above may be used. Longer residence time are possible but limit the rate and productivity of the grafting extruder. Moreover, using a peroxide with an appropriate half-life for the residence time in the extruder at the melt temperature is important. Suitable peroxides are discussed above.

Modern extruders, both modular and single barrel, feature temperature control capabilities across various sections. It is therefore possible to set, and control, different barrel temperatures along the length of the barrel. The maximum barrel temperature is the highest set temperature. Different barrel temperatures are desirable to control the energy input and the melt temperature along the length of the extruder, and to control the extrudate temperature.

Extruder barrels house the screws or rotors of the extruder. They serve to contain the polymer in the extruder, and are designed to provide heating or cooling to the polymer being processed through heaters and cooling channels. They are designed to withstand high temperatures and pressures encountered during the extrusion operation.

The screws/rotors can be rotated at varying speeds usually up to 1500 rpm. The rotating of the screw/rotors also inputs energy into the material being processed in the extruder, raises its temperature, and thereby facilitates melting, mixing, and reaction.

### Processing Results

In one embodiment, the process for manufacturing an epoxy-functionalized ethylene-based polymer results in a graft level of at least 0.4 wt %, of at least 2 wt %, of at least 3%, or of at least 4%.

In one embodiment, the process for manufacturing an epoxy-functionalized ethylene-based polymer results in graft efficiency greater than or equal to 30%, greater than or equal to 40%, or greater than or equal to 50%.

In one or more embodiments, graft levels of at least 5% and graft efficiencies of at least 65% were achieved without significant crosslinking when glycidyl methacrylate (GMA) as the epoxy-functional monomer and trimethylolpropane triacrylate (TMPTA) as a coagent.

### Epoxy-Functionalized Ethylene-Based Polymer

Also provided is an epoxy-functionalized ethylene-based polymer formed from an embodiment, or a combination of the embodiments described herein.

In one embodiment, the epoxy-functionalized ethylene-based polymer has a melt viscosity, at 350° F. (177° C.), less than or equal to 50,000 cP, less than or equal to 40,000 cP, less than or equal to 30,000 cP, less than or equal to 20,000 cP, or less than or equal to 15,000 cP. In one embodiment, the epoxy-functionalized ethylene-based polymer has a melt viscosity, at 350° F. (177° C.), from 6,500 to 50,000 cP, from 6,500 to 30,000 cP, or from 10,000 cP to 30,000 cP. It is important that the epoxy-functionalized ethylene-based polymer have a melt viscosity at 350° F. (177° C.) of less than or equal to 50,000 cP as this demonstrates an unacceptable level of crosslinking has been avoided. An excessive amount of crosslinking may hinder grafting efficiency. Moreover, as discussed above, it is important for the epoxy-functionalized ethylene-based polymer to have a low viscosity in order to achieve good compatibilization in packaging recycling.

Also provided is a compatibilized formulation comprising the epoxy-functionalized ethylene-based polymer formed from an embodiment, or a combination of the embodiments described herein.

In some embodiments, the compatibilized formulation may comprise between 1 and 10 wt % epoxy-functionalized ethylene-base polymer, between 2 and 10 wt % epoxy-functionalized ethylene-base polymer, between 4 and 10 wt % epoxy-functionalized ethylene-base polymer, between 5 and 8 wt % epoxy-functionalized ethylene-base polymer, between 5 and 7 wt % epoxy-functionalized ethylene-base polymer. In one embodiment, the compatibilized formulation comprises 6 wt % epoxy-functionalized ethylene-base polymer.

Compatibilized formulations incorporating the epoxy-functionalized ethylene-based polymer produced in accordance with the present disclosure may comprise an Izod impact strength (at ambient temperature) greater than or equal to 200 J/m, greater than or equal to 250 J/m, greater than or equal to 300 J/m, or greater than or equal to 335 J/m, when measured via ASTM D256 Method A, as described in the test methods section of the present disclosure.

Compatibilized formulations incorporating the epoxy-functionalized ethylene-based polymer produced in accordance with the present disclosure may comprise an elongation at break greater than or equal to 50%, greater than or equal to 60%, greater than or equal to 70%, or greater than or equal to 75%, when measured via the ASTM D4703 per Appendix A.1 (Procedure C), as described in the test methods section of the present disclosure.

Compatibilized formulations incorporating the epoxy-functionalized ethylene-based polymer produced in accordance with the present disclosure may comprise a stress at break greater than or equal to 1000 psi, greater than or equal to 1100 psi, greater than or equal to 1200 psi, or greater than or equal to 1300 psi, when measured via the ASTM D4703 per Appendix A.1 (Procedure C), as described in the test methods section of the present disclosure.

Compatibilized formulations incorporating the epoxy-functionalized ethylene-based polymer produced in accordance with the present disclosure may comprise a low shear viscosity at 275° C. and a frequency of 0.1 rad/s greater than or equal to 10.000 Pa·s, greater than or equal to 10,500 Pas, greater than or equal to 11.500 Pas, or greater than or equal to 12,500 Pa's, when measured according to the dynamic mechanical spectroscopy (DMS) method as described in the test methods section of the present disclosure.

### Definitions

The term “composition,” as used herein, includes a material or mixture of materials which comprise the composition, as well as reaction products and decomposition products formed from the materials of the composition. Typically, any reaction products and/or decomposition products are present in trace amounts.

The term “polymer” refers to a polymeric compound prepared by polymerizing monomers, whether of a same or a different type. The generic term polymer thus embraces the term “homopolymer.” which usually refers to a polymer prepared from only one type of monomer as well as “copolymer.” which refers to a polymer prepared from two or more different monomers. The term “interpolymer.” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than or equal to 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LLDPE.” includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923, 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342, 5,854,045). The LLDPE resins can be made via gas-phase, solution-phase, or slurry polymerization or any combination thereof, using any type of reactor or reactor configuration known in the art.

The term “HDPE” refers to ethylene-based polymers having densities greater than about 0.940 g/cc, which are generally prepared with Ziegler-Natta catalysts, chrome catalysts or even metallocene catalysts.

“Polypropylene” or “propylene based polymer” shall mean polymers comprising greater than or equal to 50% by mole of units derived from propylene monomer. This includes propylene-based homopolymers or copolymers (meaning units derived from two or more comonomers). Common forms of ethylene-based polymers known in the art include, but are not limited to, impact polypropylene copolymers (icPP), random copolymers (rcPP), polypropylene homopolymers (hPP), propylene/ethylene copolymers (POE plastomers), and polypropylene reactor blends.

The term “olefin-based polymer.” as used herein, refers to a polymer that comprises, in polymerized form. 50 wt % or a majority amount of an olefin monomer, for example, ethylene or propylene, based on the weight of the polymer, and optionally may comprise one or more comonomers. In one embodiment, the olefin-based polymer comprises a majority amount of the olefin monomer (based on the weight of the polymer) and optionally may comprise one or more comonomers. Olefin-based polymers are also referred to herein as “polyolefins.”

The term, “ethylene/α-olefin interpolymer,” as used herein, refers to an interpolymer that comprises, in polymerized form, at least 50 wt % or a majority amount of ethylene monomer (based on the weight of the interpolymer), and at least one α-olefin. In one embodiment, the ethylene/α-olefin interpolymer comprises a majority amount of ethylene monomer (based on the weight of the ethylene-based interpolymer) and at least one α-olefin.

The term, “ethylene/α-olefin copolymer.” as used herein, refers to a copolymer that comprises, in polymerized form, at least 50 wt % or a majority amount of ethylene monomer (based on the weight of the copolymer), and an α-olefin, as the only two monomer types. In one embodiment, the ethylene/α-olefin copolymer comprises a majority amount of ethylene monomer (based on the weight of the ethylene-based copolymer) and an α-olefin as the only monomer types.

The term “multifunctional” when used in conjunction with a functional group as a descriptor of a coagent indicates that the coagent is terminated in at least two locations with the corresponding functional group. For example, the phrase “vinyl terminated multifunctional coagent” refers to a coagent comprising a molecule that is terminated in at least two locations with a vinyl functional group. Similarly, the phrase “acrylate terminated multifunctional coagent” refers to a coagent comprising molecules terminated in at least two locations with an acrylate functional group. Moreover, because an acrylate functional group contains a vinyl functional group, an acrylate terminated multifunctional coagent represents one form of a vinyl terminated multifunctional coagent.

The terms “comprising.” “including.” “having.” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound. whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

For the purposes of describing and defining the present invention, it is noted that recitations herein of “at least one” component, element, etc., should not be used to create an inference that the alternative use of the articles “a” or “an” should be limited to a single component, element, etc. For example, reference to “a” component includes aspects having two or more such components, unless the context clearly indicates otherwise.

It is noted that terms like “preferably.” “commonly.” and “typically.” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited. it is in no way intended that an order or orientation be inferred, in any respect. This holds for any possible non-express basis for interpretation, including: matters of logic with respect to arrangement of steps, operational flow. order of components, or orientation of components; plain meaning derived from grammatical organization or punctuation, and; the number or type of embodiments described in the specification.

### Test Methods

The test methods as used herein include the following:

### Epoxide Content-Fourier Transform Infrared Spectroscopy (FTIR) Analysis

The concentration of epoxide groups was determined by the ratio of peak heights of the epoxide group (at the corresponding wave number) to the polymer reference peak, which, in the case of polyethylene, is at a wave number of 2751 cm-1. The epoxide content was calculated by multiplying this ratio with the appropriate calibration constants. The equation used for GMA grafted polyolefins, wherein GMA is represented by a peak at about 847 cm-1 (and with reference peak for polyethylene) has the following form, as shown in Equation 1.

$$GMA ( wt \% ) = A * \{ [ FTIR PeakHeight @ 847 {cm}^{- 1} ] / [ FTIR PeakHeight @ 2751 {cm}^{- 1} ] - B \qquad ( Eqn . 1 )$$

The calibration constants A (12.403) and B (0.168) can be determined using known calibration standards. The actual calibration constant may differ slightly depending on the instrument and polymer.

The sample preparation procedure begins by making a pressing, typically 0.05 to 0.15 millimeters in thickness, in a heated press, between two protective films, at 150-180° C. for ˜3-5 min. MYLAR and TEFLON are suitable protective films to protect the sample from the platens. Platens should be under pressure (˜10 tons) for about five minutes. The sample was allowed to cool to room temperature and then vacuum stripped to remove any unreacted residual GMA. After stripping, the sample was placed in an appropriate sample holder, and then scanned in the FTIR. A background scan should be run before each sample scan, or as needed. The precision of the test is good, with an inherent variability of less than +5%.

### Grafting Efficiency

Grafting efficiency was determined by normalizing the wt % GMA determined by FTIR with the wt % fed into the formulation.

### Melt Viscosity

Melt viscosity was measured in accordance with ASTM D 3236 (177° C. 350° F.), using a Brookfield Digital Viscometer (Model DV-III, version 3) and disposable aluminum sample chambers. The spindle used, in general, was a SC-31 hot-melt spindle, suitable for measuring viscosities in the range from 10 to 100,000 centipoise. The sample was poured into the chamber, which was, in turn, inserted into a Brookfield Thermosel, and locked into place. The sample chamber has a notch on the bottom that fits the bottom of the Brookfield Thermosel, to ensure that the chamber is not allowed to turn when the spindle is inserted and spinning. The sample (approximately 8-10 grams of resin) was heated to the required temperature, until the melted sample was about one inch below the top of the sample chamber. The viscometer apparatus was lowered, and the spindle submerged into the sample chamber. Lowering was continued, until the brackets on the viscometer align on the Thermosel. The viscometer was turned on, and set to operate at a shear rate which leads to a torque reading in the range of 40 to 60 percent of the total torque capacity, based on the rpm output of the viscometer. Readings were taken every minute for about 15 minutes, or until the values stabilize, at which point, a final reading was recorded.

### Low Shear Viscosity

For preparation, each test sample was initially placed into a 1.5 inch diameter chase of thickness 3.10 mm and compression molded at a pressure of 25,000 lbs. for 6.5 min. at 190° C. with a Carver Hydraulic Press (Model #4095.4NE2003). After cooling to room temperature, the samples were extracted to await rheological testing.

DMS (dynamic mechanical spectroscopy) frequency sweeps were conducted using 25 mm parallel plates at frequencies ranging from 0.1 to 100 rad/s. The test gap separating the plates was 1.8 mm and a 10% strain was applied, satisfying linear viscoelastic conditions. Each test was conducted under nitrogen atmosphere and isothermal conditions at 275° C. To initiate the DMS test, the rheometer oven was first allowed to equilibrate at the desired testing temperature for at least 30 min, before loading the sample into the test geometry. The sample was then equilibrated in the oven, with the door closed, for 1 min. The test gap was then set to 1.8 mm, and the sample was allotted 5 min, to relax the resulting normal force. Afterwards, the oven was quickly opened, and the sample was trimmed so that no bulge was present. The DMS measurement was then initiated after reclosing the oven. During the test, the shear elastic modulus (G′), viscous modulus (G″) and complex viscosity (η*) were measured. The complex viscosity measured at a frequency of 0.1 rad/s is referred to herein as the low shear viscosity.

All DMS frequency tests were conducted on either ARES-G2 or DHR-3 rheometers, both of which were manufactured by TA Instruments. Data analyses were conducted via TA Instruments TRIOS software.

### Tensile Properties

Samples were compression molded at 275° C., to a nominal thickness of 0.125 inch according to ASTM D4703 per Appendix A.1 (Procedure C). Type I samples were die cut from the sheet and conditioned at 23 (±2° C.) and 50 (±10) % relative humidity for at least 40 hours.

The Type I samples were tested in tension according to D638 (Standard Test Method for Tensile Properties of Plastics). The test speed was 2 inches/min. crosshead displacement. The strain was measured using an extensometer attached to the sample at an initial gauge length of 2 inches. Tensile testing was conducted at 23+/−2° C.

### Impact Resistance

Notched Izod impact strength testing was performed according to ASTM D256 Method A. Samples were fabricated from compression molded sheets made according to ASTM D4703 per Annex A.1 (Procedure C) to a nominal thickness of 0.125 inches.

Specimens were cut from the sheet with an appropriate die to give samples 2.5 inches in length and 0.5 inches in width. The samples were notched on the long side in the thickness direction using an automated notcher to leave a ligament width of 0.4 inches. The notching half angle was 22.5° and the radius of curvature at the tip was 0.01 inch. The samples were conditioned for at least 40 hours at 23+/−2° C. and 50+/−10% relative humidity. Impact testing was conducted at 23+/−2° C.

Specimens were loaded into the Izod tester per ASTM D256 Method A, with the notch directed towards the impactor. The pendulum was released and the energy absorbed during the test was automatically recorded. The specimen was examined post-test and the type of failure was noted (complete, hinged, partial or no-break). Five replicates were tested per sample.

### Examples

The following examples illustrate features of the present disclosure but are not intended to limit the scope of the disclosure. The following experiments analyzed the performance of embodiments of the low viscosity functionalized ethylene copolymers described herein.

The materials used in this study are shown in Table 1.

TABLE 1
Reagents

| Trade Name | Description/CAS No. | Supplier |
|---|---|---|
| AFFINITY ™ | Ethylene Octene | The Dow Chemical |
| GA1875* | copolymer | Company |
| Glycidyl | 106-91-2 | Sigma Aldrich |
| Methacrylate | | |
| (GMA) | | |
| Luperox 101 | 2,5-Bis(tert-butylperoxy)- | Arkema |
| | 2,5-dimethylhexane, | |
| | 78-63-7 | |
| TMPTA | Trimethylolpropane | Sigma Aldrich |
| | triacrylate, 15625-89-5 | |
| DVB | Divinylbenzene, 1321-74-0 | Sigma Aldrich |
| SARET 206 | Ethylene glycol | Sartomer |
| | dimethacrylate, 97-90-5 | |
| SARET 239 | 1,6 Hexanediol | Sartomer |
| | dimethacrylate, 6606-59-3 | |
| SARET 230 | Ethylene glycol | Sartomer |
| | diacrylate, 2274-11-5 | |
| SARET 259 | Polyethylene glycol | Sartomer |
| | diacrylate, 26570-48-9 | |

*Density of 0.87 g/cc and melt viscosity of 6700 cP (177° C. (350° F.))

### Equipment and Experimental Conditions

To produce the Examples and Comparative Examples described below, each grafting reaction was performed on a 26 mm co-rotating twin screw extruder (ZSK-26 from Coperion Corp.). The extruder was configured with 15 barrels (60 L/D). The maximum screw speed was 1200 rpm, and the maximum motor output was 40 HP. The extruder was equipped with “loss-in-weight feeders.” GMA and GMA-coagent mix was injected at Barrel 3 and the peroxide soaked onto the ethylene copolymer pellets was fed through the main feed port. Nitrogen at 5 standard cubic foot per hour (SCFH) was used to purge first barrel section to maintain an inert atmosphere and minimize oxidation. A vacuum (˜15″ Hg) was pulled on Barrel 13. A two-hole die was used to produce strands which were cut into pellets using a strand cutter. The run rate was 8 lbs/hr and a screw speed of 375 rpm was used. Barrel 1 was water cooled; Barrels 2-4 were maintained at 50-70° C.; Barrels 6-11 were maintained at 220° C.; and Barrels 12-15 were maintained at 160° C.

The compositions of the Examples and Comparative Examples are shown in Table 2, along with the graft level (GMA wt %), graft efficiency (%), and viscosity, each determined according to the test methods described above.

TABLE 2
GMA Grafting Examples and Comparative
Examples; Compositions and Results

| | Control, | | Low | Low | Low |
|---|---|---|---|---|---|
| | no | Control | level 1 | level 2 | level 3 |
| | coagent | TMPTA | TMPTA | TMPTA | TMPTA |
| Example | 1 | 2 | 3 | 4 | 5 |
| Inventive/Comparative | Comp | Inv | Inv | Inv | Inv |
| AFFINITY ™ | 94.4 | 89.0 | 92.8 | 95.6 | 90.5 |
| GA1875 | | | | | |
| GMA | 5.1 | 7.8 | 5.1 | 3.1 | 7.8 |
| DBPH (Peroxide) - | 0.4 | 0.6 | 0.4 | 0.3 | 0.6 |
| Luperox 101 | | | | | |
| TMPTA | — | 2.6 | 1.7 | 1.1 | 1.1 |
| SARET 206 | — | — | — | — | — |
| SARET 239 | — | — | — | — | — |
| SARET 230 | — | — | — | — | — |
| SARET 259 | — | — | — | — | — |
| Divinylbenzene (DVB) | — | — | — | — | — |
| Test Results | | | | | |
| Graft level | 0.95 | 4.89 | 2.74 | 1.37 | 2.34 |
| (GMA wt %) | | | | | |
| Graft efficiency (%) | 18 | 63 | 54 | 44 | 30 |
| Viscosity @ | 6274 | 26144 | 8893 | 7663 | 8218 |
| 177° C., cP | | | | | |

| | | Low | | Low |
|---|---|---|---|---|
| | Control 1 | level 1 | Control 2 | level 2 |
| | Dimeth- | Dimeth- | Dimeth- | Dimeth- |
| | acrylate | acrylate | acrylate | acrylate |
| Example | 6 | 7 | 8 | 9 |
| Inventive/Comparative | Comp | Comp | Comp | Comp |
| AFFINITY ™ | 89.0 | 92.8 | 89.0 | 92.8 |
| GA1875 | | | | |
| GMA | 7.8 | 5.1 | 7.8 | 5.1 |
| DBPH (Peroxide) - | 0.6 | 0.4 | 0.6 | 0.4 |
| Luperox 101 | | | | |
| TMPTA | — | — | — | — |
| SARET 206 | 2.6 | 1.7 | — | — |
| SARET 239 | — | — | 2.6 | 1.7 |
| SARET 230 | — | — | — | — |
| SARET 259 | — | — | — | — |
| Divinylbenzene (DVB) | — | — | — | — |
| Test Results | | | | |
| Graft level | 1.27 | 0.63 | 1.27 | 0.68 |
| (GMA wt %) | | | | |
| Graft efficiency (%) | 16 | 12 | 16 | 13 |
| Viscosity @ | 6058 | 5948 | 5298 | 5914 |
| 177° C., cP | | | | |

| | Low | | Diac- | Diac- |
|---|---|---|---|---|
| | DVB | DVB | rylate 1 | rylate 2 |
| Example | 10 | 11 | 12 | 13 |
| Inventive/Comparative | Inv | Inv | Inv | Inv |
| AFFINITY ™ | 90.9 | 89.5 | 92.8 | 92.8 |
| GA1875 | | | | |
| GMA | 7.9 | 7.8 | 5.6 | 5.1 |
| DBPH (Peroxide) - | 0.6 | 0.6 | 0.4 | 0.4 |
| Luperox 101 | | | | |
| TMPTA | — | — | — | — |
| SARET 206 | — | — | — | — |
| SARET 239 | — | — | — | — |
| SARET 230 | — | — | 1.2 | — |
| SARET 259 | — | — | — | 1.7 |
| Divinylbenzene (DVB) | 0.7 | 2.1 | — | — |
| Test Results | | | | |
| Graft level | 2.5 | 4.37 | 2.59 | 2.6 |
| (GMA wt %) | | | | |
| Graft efficiency (%) | 32 | 56 | 46 | 51 |
| Viscosity @ | 8803 | 16436 | 7828 | 7753 |
| 177° C., cP* | | | | |

*1 cP = 0.001 Pa · s

The results shown in Table 2 demonstrate the low grafting level and efficiency when no coagent is used during the grafting process. In other words, the grafting reaction of an epoxide group, in this case, GMA, onto a low viscosity polyolefin can be enhanced when using a coagent. The results in Table 2 further indicate the effect of various coagents. In particular, when the results for the Examples are compared with the Comparative Examples, it becomes clear that multifunctional vinyl or multifunctional acrylate coagents are used, the graft efficiencies are at least 30%. However, when no coagent is used or a multifunctional methacrylate terminated coagent is used, the graft efficiencies are consistently less than 20%. Further, the epoxy-functionalized ethylene-based polymers show minimal viscosity increases with the preferred coagents, thereby indicating lack of crosslinking. The relatively higher viscosity for Examples 2 and 11 is expected as both of these examples have a high level of peroxide and coagent and resulting high graft level.

### Evaluation in PE-PET Compatibilized Formulations

The materials used to produce experimental compatibilized formulations are shown below in Table 3.

To produce the formulations, the samples were mixed using a RS5000 batch mixer from Rheometers Services Inc. The bowl, which can mix batches up to 250 g, was used with roller blade rotors. After initial fluxing of the base polymer (polyethylene and polyethylene terephthalate) for few minutes, the compatibilizer (GMA grafted polymer) was loaded in the mixer at a low speed. Following incorporation of all other ingredients, the batches were mixed using a rotor speed of 30-60 rpm and a bowl temperature of 275° C. The mixing was continued for an additional 10-15 minutes. After mixing, each batch was collected on a glass reinforced Teflon sheet, pressed into a flat “patty” on a compression molder and cooled to ambient temperature. Compression molded samples for mechanical testing were prepared from each flat “patty” using the procedures described above in the test methods section. The results from the DMS measurements, Izod impact strength, and tensile testing are also shown in Table 3.

TABLE 3
Compatiblization Using GMA Grafted Polymer*

| Formulation | RC 1 | RC 2 | RC 3 | RC 4 | RC 5 |
|---|---|---|---|---|---|
| Inventive/Comparative | Comp | Inv | Inv | Inv | Comp |
| DOWLEX 2045G | 61.7 | 58 | 58 | 58 | 58 |
| LDPE 501I | 13.8 | 13 | 13 | 13 | 13 |
| PET | 24.5 | 23 | 23 | 23 | 23 |
| Inventive | — | 6 | — | — | — |
| Example 3 | | | | | |
| Inventive | — | — | 6 | — | — |
| Example 4 | | | | | |
| Inventive | — | — | — | 6 | — |
| Example 5 | | | | | |
| ELVALOY PTW | — | — | — | — | 6 |
| Test Results | | | | | |
| Izod impact | 131 | 340 | 339 | 490 | 492 |
| strength (J/m) | | | | | |
| Elongation | 38 | 78 | 108 | 124 | 276 |
| at break (%) | | | | | |
| Stress at | 1620 | 1372 | 1328 | 1350 | 1966 |
| break (psi) | | | | | |
| Low shear | 17928 | 37749 | 29089 | 28645 | 77783 |
| viscosity^{†} | | | | | |

*Table values are weight percent (wt %), based on the total weight of the formulation
^{†}Measured at 0.1 rad/s @ 275° C. using the DMS method described in the test methods section (units reported in Pa · s)
DOWLEX ™ 2045G is a linear low density polyethylene (LLDPE) available from Dow Inc.
LDPE 501I is a low density polyethylene (LDPE) available from Dow Inc.
ELVALOY ™ PTW is an ethylene terpolymer based on GMA available from Dow Inc.
PET is polyethylene terephthalate

As can be seen from the results in Table 3, when the GMA grafted ethylene-based polymers from Inventive Examples 3, 4, and 5 are incorporated in compatibilized formulations (RC 2, RC 3, and RC 4), the resulting impact strength and the ductility (elongation at break) are improved. The formulation without GMA grafted ethylene-based polymer shows significantly lower impact strength and elongation at break. When compared to the commercial compatibilizer (EVALOY PTW; RC 5), the inventive grafts in formulations RC 2, RC 3, and RC 4 show better flow properties (indicated by lower viscosity).

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A process for manufacturing an epoxy-functionalized ethylene-based polymer, the process comprising:
extruding a reactive mixture to form the epoxy-functionalized ethylene-based polymer, wherein the reactive mixture comprises:
an ethylene-based polymer having a viscosity less than or equal to 50,000 cP at 177° C.;
an epoxy-functional monomer;
a peroxide; and
a vinyl terminated multifunctional coagent having a functionality of 2 or more.

2. The process of claim 1, wherein the epoxy-functionalized ethylene-based polymer has a graft efficiency greater than or equal to 30%.

3. The process of claim 1, wherein the epoxy-functional monomer comprises one or more of glycidyl acrylate, glycidyl methacrylate (GMA), and allyl glycidyl ether (AGE).

4. The process of claim 1, wherein the reactive mixture comprises 0.3 to 10.0 wt % epoxy-functional monomer and 80 to 97 wt % ethylene-based polymer.

5. The process of claim 1, wherein the reactive mixture comprises 0.1 to 5.0 wt % vinyl terminated multifunctional coagent.

6. The process of claim 1, wherein the vinyl terminated multifunctional coagent comprises divinylbenzene.

7. The process of claim 1, wherein the vinyl terminated multifunctional coagent comprises an acrylate terminated multifunctional coagent.

8. The process of claim 7, wherein the acrylate terminated multifunctional coagent comprises trimethylolpropane triacrylate (TMPTA).

9. The process of claim 7, wherein the acrylate terminated multifunctional coagent comprises alkylene glycol diacrylate or polyalkylene glycol diacrylate.

10. The process of claim 1, wherein the viscosity of the ethylene-based polymer is from 5,000 to 50,000 cP (at 177° C.).

11. The process of claim 1, wherein the epoxy-functionalized ethylene-based polymer comprises a viscosity from 6,500 to 50,000 cP, or from 6,500 to 30,000 cP (at 177° C.).

12. The process of claim 1, wherein the ethylene-based polymer comprises ethylene/α-olefin copolymer comprising a density from 0.850 to 0.900 g/cc.

13. The process of claim 1, wherein extruding the reactive mixture is performed using a twin screw extruder.

14. The epoxy-functionalized ethylene-based polymer produced by the process of claim 1.

15. A compatibilizer formulation comprising the epoxy-functionalized ethylene-based polymer of claim 14.
